(19) United States
(12) Patent Application Publication
(10) Pub. No.: US 2016/0350742 A1
(43) Pub. Date: Dec. 1, 2016

(54) SYSTEM AND METHOD FOR TRANSMITTING AND AND RECEIVING TRANSACTION INFORMATION

(71) Applicant: VISA INTERNATIONAL SERVICE ASSOCIATION, San Francisco, CA (US)

(72) Inventors: Alan Joseph O'Regan, Cape Town (ZA); Horatio Nelson Huxham, Cape Town (ZA); Tara Anne Moss, Cape Town (ZA); Hough Van Wyk, Cape Town (ZA)

(21) Appl. No.: 15/112,947

(22) PCT Filed: Feb. 19, 2015
(86) PCT No.: PCT/IB2015/051265

§ 371 Date: Jul. 20, 2016

(30) Foreign Application Priority Data
Feb. 21, 2014 (ZA) 2014/01318

(51) Int. Cl. G06Q 20/32

(52) U.S. Cl. CPC G06Q 20/3224; G06Q 20/3276

(57) ABSTRACT

A method and system for transmitting and receiving transaction information are provided. The method for transmitting transaction information is performed on a computing device and includes: accessing transaction information to be transmitted and selecting an electronic file. The metadata stored in the electronic file is edited to insert the transaction information into one or more fields of the metadata to provide modified metadata of the electronic file. The electronic file with the modified metadata is transmitted to a receiving entity for processing of the transaction information. The transaction information may be in the form of payment credentials usable to enable a payment transaction.

### CROSS-REFERENCE TO RELATED APPLICATION

This application claims priority to South African provisional patent application number 2014/01318 filed on 21 Feb. 2014 which is incorporated by reference herein.

### FIELD OF THE INVENTION

This invention relates to the field of transactions such as payment transactions in which payment or personal credentials and related information are transmitted electronically.

### BACKGROUND TO THE INVENTION

Mobile device usage has increased dramatically in recent years. Due to the various capabilities of modern mobile devices, they are used to perform an ever-increasing number of tasks. One of these is assisting with the processing of transactions of a user.

Some systems allow a user to scan a barcode on a product, and process payment for the product by means of the user's mobile device. An electronic receipt can then be shown to a cashier to allow the user to leave a retail store with the paid-for product. However, some mobile devices may not be able to scan barcodes on products.

Other systems allow for the capture of a coupon as an image by a user's mobile device and transmitting the image of the coupon to a payment service provider where the image is analysed.

Applicant is aware of a system in which a mobile device is used to assist in the transfer of payment credentials. An issuing bank, in response to a payment request, requests a user to take a self-picture and transmit the picture back to the issuing bank. Facial recognition is then performed on the transmitted image by the bank. If the picture is of an authorized user, the transaction is approved. This method, however, requires the initialization of the transaction by one means, and both the receiving and transmission of data by the user's mobile device. This may be time-consuming at a point-of-sale.

Payment via mobile devices may also be carried out by near field communication (NFC) of payment credentials to a point of sale (POS) device. A user may tap or bring his mobile device into close proximity to the POS device in order to transfer the payment credentials.

The payment credentials are known to be stored on a mobile device in a mobile wallet having a dedicated chip in the form of a secure element or using a virtual representation of a smart card using only software in the form of host card emulation (HCE). In addition, tokenization payment techniques have been developed which replace personally identifiable information such as primary account numbers with a surrogate secure token which maps to the payment credentials in a secure tokenization system. The token is transmitted to a merchant instead of a primary account number which ensures that the actual cardholder data not transmitted.

Some mobile devices are not NFC enabled for payment credential transfer and other methods of transferring payment credentials are needed.

### SUMMARY OF THE INVENTION

According to a first aspect of the present invention there is provided a method for transmitting transaction information, the method performed on a computing device and including the steps of: accessing transaction information to be transmitted; selecting an electronic file; editing metadata stored in the electronic file to insert the transaction information into one or more fields of the metadata to provide modified metadata of the electronic file; and transmitting the electronic file with the modified metadata to a receiving entity for processing of the transaction information.

The transaction information may be in the form of payment credentials usable to enable a payment transaction. The payment credentials may be one or more of the group of: encrypted payment credentials, a token referencing payment credentials, or single use payment credentials.

The content of the electronic file may include information to be used in the transaction. One or more existing fields of the metadata stored in the electronic file may also be kept in the modified metadata and used in the transaction. The one or more existing fields of the metadata include one or more of: time and date information, and location information.

In one embodiment, selecting an electronic file includes capturing as an image file an image relating to a product or a party to the transaction in respect of which a user wishes to make a financial transaction. The image may be an image of any one or more of the group of: a product, a barcode, a two-dimensional barcode, a quick response (QR) code, a retailer identifier, and a person.

Further features of the invention provide for the method to include the step of encrypting the payment credentials; and to include the step of replacing at least some metadata with information related to the payee.

Yet further features of the invention provide for the metadata to include image file properties, and for the metadata to be in the format of exchangeable image file format or the like.

According to a second aspect of the present invention there is provided a method for receiving transaction information, the method performed on a computing device at a receiving entity and including the steps of: receiving an electronic file with modified metadata; extracting transaction information from one or more fields of the modified metadata stored in the electronic file; and using the transaction information to process a transaction.

In one embodiment, the method is performed on a payment authorisation server and includes the steps of: receiving an image file having payment credentials in metadata associated therewith from a user, the image of the image file relating a product or a party to the transaction in respect of which a user wishes to make a financial transaction; analysing the image file in order to determine what product or party the image file relates to; and processing the payment credentials to effect the payment to an entity associated with the product or party.

The method may include the step of looking up an entity associated with the product or party or a product or party identifier in a database associated with the server. The party may be a payee or a payor.

According to a third aspect of the present invention there is provided a system for transmitting transaction information comprising including: a transaction information accessing component for accessing transaction information to be transmitted; an electronic file selecting component for selecting an electronic file; a file modification component for editing metadata stored in the electronic file to insert the transaction information into one or more fields of the metadata to provide modified metadata of the electronic file; and a communication component for transmitting the electronic file with the modified metadata to a receiving entity for processing of the transaction information.

The system may also include a capturing component for capturing an electronic file in the form of an image file having an image relating to at least a product or a party in respect of which a user wishes to make a financial transaction.

The system may also include an encryption component for encrypting the transaction information prior to editing metadata to insert the transaction information.

According to a fourth aspect of the present invention there is provided a system for receiving transaction information at a receiving entity comprising: a communication component for receiving an electronic file with modified metadata; an extracting component for extracting transaction information from one or more fields of the modified metadata stored in the electronic file; and a transaction processing component for using the transaction information to process a transaction.

In one embodiment, the communication component is for receiving an image file having payment credentials in metadata associated therewith from a user and the image of the image file relates to at least a product or a party to the transaction in respect of which a user wishes to make a financial transaction; and the system may also include: an analysing component for analysing the image file in order to determine what product or party the image file relates to; and a payment processing component for processing the payment credentials to effect the payment to an entity associated with the product or party.

According to a fifth aspect of the present invention there is provided a computer program product for transmitting transaction information, the computer program product comprising a computer-readable medium having stored computer-readable program code for performing the steps of: accessing transaction information to be transmitted; selecting an electronic file; editing metadata stored in the electronic file to insert the transaction information into one or more fields of the metadata to provide modified metadata of the electronic file; and transmitting the electronic file with the modified metadata to a receiving entity for processing of the transaction information.

According to a sixth aspect of the present invention there is provided a computer program product for receiving transaction information, the computer program product comprising a computer-readable medium having stored computer-readable program code for performing the steps of: receiving an image file having payment credentials in metadata associated therewith from a user, the image of the image file relating to at least a product or a payee in respect of which a user wishes to make a financial transaction; analysing the image file in order to determine what product or payee the image file relates to; and processing the payment credentials to effect the payment to an entity associated with the product or payee.

### BRIEF DESCRIPTION OF THE DRAWINGS

The invention will now be described, by way of example only, with reference to the accompanying representations in which:

FIG. 1 illustrates an example system for transmitting transaction information according to the invention;

FIG. 2 illustrates an example method of transmitting transaction information as performed on a computing device according to the invention;

FIG. 3 illustrates an example method of transmitting transaction information as performed on a receiving entity according to the present invention;

FIG. 4 illustrates a system for transmitting payment credentials according to a first embodiment of the invention;

FIG. 5 illustrates a method carried out at a computing device according to the embodiment of FIG. 4;

FIG. 6 illustrates a method carried out at a receiving entity according to the embodiment of FIG. 4;

FIG. 7 illustrates a system for transmitting payment credentials according to a second embodiment of the invention;

FIG. 8 illustrates an example computing device in accordance with the invention;

FIG. 9 illustrates an example receiving entity in accordance with the invention;

FIG. 10 illustrates an embodiment of an exemplary computing device in accordance with the present invention; and

FIG. 11 illustrates an embodiment of an exemplary mobile device in accordance with the present invention.

### DETAILED DESCRIPTION WITH REFERENCE TO THE DRAWINGS

A method and system are described in which transaction information such as payment credentials or personal identity information are transferred in an electronic file in the metadata or attribute fields of the file.

Many forms of electronic files include metadata which provides information relating to the file. Electronic files may include document files, image files, spreadsheets, web pages, music or video files, email messages, etc. The metadata is stored in the electronic file and is usually hidden unless accessed. In some systems, right-clicking in a graphic user interface on the file icon or selecting “properties” from a menu will display the properties of the file which include the metadata. In the case of an email message, the metadata may be considered to be the information contained in the header of the email message. In the case of a web page, the metadata is not viewable on the page but is machine parsable, for example in the form of meta tags.

Some metadata is created automatically and may not be edited; however, some fields may be edited. This is often done in order to remove personal information before sharing the electronic file; however, it may also be used to allow a user to input information. Editable fields may include fields such as the title, subject, tags, categories, comments, author fields, etc. These fields may be used in the described method.

Metadata of an image files may be generated when the camera captures the image and may include additional information. An example of such a metadata image file format is exchangeable image file (Exif) format, which forms part of a Joint Photographic Experts Group (JPEG) image file. Metadata files are typically automatically created by cameras and may include, but are not limited to, information such as: the date, time and global positioning system (GPS) coordinates at which the picture was taken; specific camera settings at the time that the picture was taken, for example orientation, aperture, flash status, shutter speed, focal length, metering mode and ISO speed information; a thumbnail for previewing purposes; image description; and copyright information. Metadata is particularly useful for photo editing purposes.

Payment systems and other transaction systems using a computing device, either a mobile device or a computer carrying out e-commerce, may require the transfer of information. Payment systems require payment credentials to be transmitted either to a POS device, or to a remote payment server. The payment credentials may include payment card details such as a primary account number (PAN) which may be encrypted before being transmitted, tokens used in tokenization systems for payments, single use payment credentials or PANs, etc. Other transaction system may require the transfer of sensitive personal information such as identity numbers, passport or license numbers, etc. in order to validate a person's identity. This may be required to obtain access to a location, or to authorize some event or transaction.

The described method and system enable transaction information such as payment credentials or other sensitive information to be transmitted in the metadata fields of an electronic file. This enables the transaction information to be sent together with the information captured in the electronic file.

In the case of the electronic file being an image file, the image may capture information relating to the transaction. Examples may include: a code such as a barcode or QR code relating to the product or merchant; a photograph of the goods to be purchased or a location at which they are being purchased; a photograph of one or more of the parties to the transaction, such as the payor or payee; etc.

In the case of the electronic file being a document file, the document may relate to the transaction and may be in the form of an invoice, receipt, product information, etc.

Some of the existing or standard file metadata may be useful for the transaction such as the time and date of the file generation or capture and the location information. Other editable metadata fields may be designated by the described method and system to have transaction information inserted into them. These editable fields may have their existing field names which may no longer be relevant, however, the receiving server may know which fields the transaction information is to be inserted into.

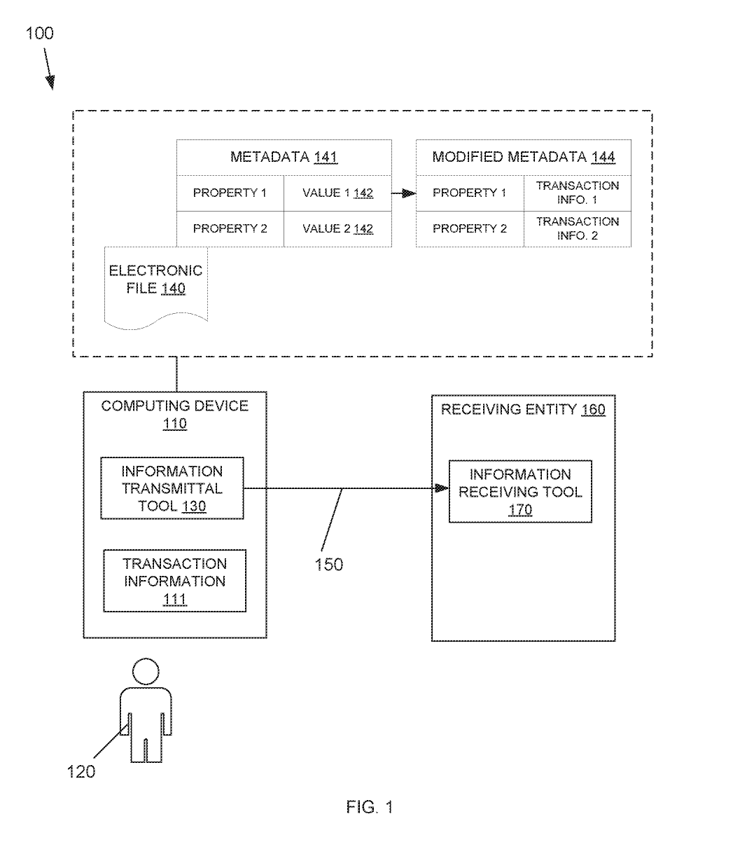

FIG. 1 is a schematic diagram of the described system (100). A user (120) may have a computing device (110) through which he or she may wish to carry out a transaction. The computing device (110) may be a computer though which e-commerce is carried out or may be a mobile device including a mobile money capability. In one embodiment, the computing device (110) may be a feature phone with limited computing capability.

The computing device (110) may have transaction information (111) such as payment credentials or sensitive information stored locally at it, accessible from a remote location, or capable of being input by a user. Such transaction information (111) may be provided in a secure encrypted form or may be a reference such as a token which maps to the sensitive information which is stored remotely in which case the token does may not need to be encrypted.

A mobile device may include a mobile wallet in the form of a secure element including payment credentials and other sensitive information such as identity information. Alternatively, the mobile wallet may use a reference or token stored at the mobile device related to remotely stored payment credentials. The mobile device may include other sensitive information which may be stored in storage element of the mobile device such as identity information.

The computing device (110) includes an information transmittal tool (130) which provides the functionality for the described method of transferring information via the metadata of an electronic file. The tool (130) may access an electronic file (140) into which the transaction information is to be added, open the metadata (141) and amend one or more editable metadata fields (142) to insert transaction information as stored or accessed from the mobile wallet (111) or other storage element of the mobile device (110) to obtain modified metadata (144).

In one embodiment, the electronic file (140) may be received at the computing device (110) after being transmitted from a creator of the file. For example, this may be an invoice or details of a purchase agreement sent by a merchant. In another embodiment, the electronic file (140) may be created by the computing device (110). For example, in the form of an image file which is created by a camera or scanner of the computing device (110).

The metadata (141) may include a list of attributes, each having a property field and a value field. One or more of the value fields (142) may be editable to insert the transaction information resulting in modified metadata (142).

The information transmittal tool (130) may send the electronic file (140) with the modified metadata (144) via any suitable communication channel (150) to another receiving entity (160). The suitable communication channel (150) may be any telecommunication or computer networking communication channel capable of transferring the electronic file (140). Examples include sending the electronic file as a multimedia messaging service (MMS) message via a cellular network, sending the electronic file as an attachment to an email sent via a network connection, sending the electronic file in the form of an email message itself, sending the electronic file from a web site to the web site service provider via a network connection, etc.

The receiving entity (160) may be a remote server such as a payment service server, an access providing server, a POS device, etc. The receiving entity (160) includes an information receiving tool (170) providing functionality to extract the transaction information from the modified metadata (144) of the received electronic file (140) in order to carry out the transaction.

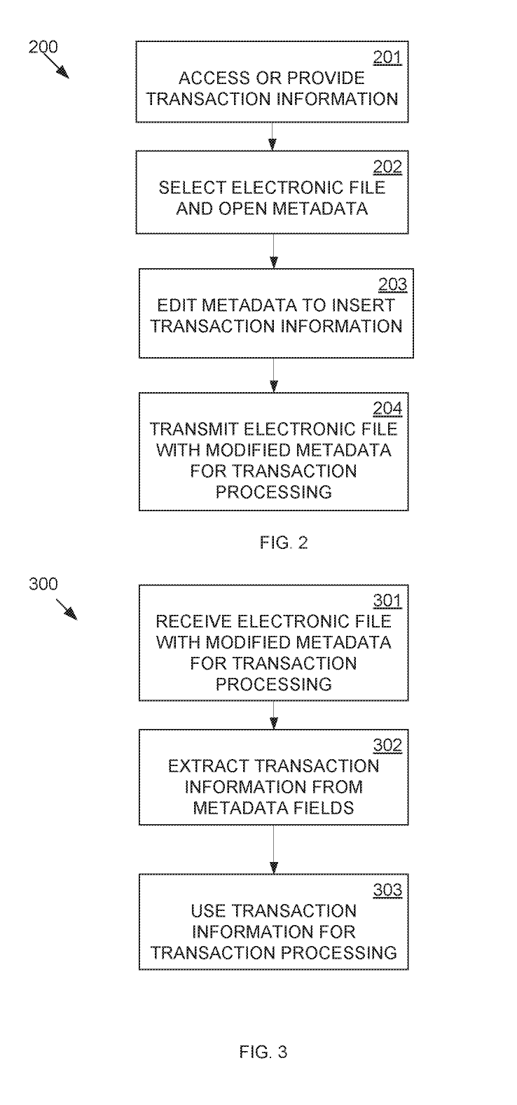

Referring to FIG. 2, a flow diagram (200) illustrates the described method as carried out at a user's computing device (110).

Transaction information may be accessed or provided (201) at the computing device. This may be financial transaction information which may be accessed from local storage on the computing device. For example, financial transaction information may be accessed from a mobile wallet of a mobile device. In another example, identify information may be accessed from a storage medium at the computing device. In a further example, transaction information may be entered manually by a user when carrying out an e-commerce transaction and may be taken from a card in the possession of the user. The transaction information may be encrypted if it is not already in a secure form for transmission.

An electronic file may be selected (202) by a user. The electronic file may be a file stored on the computing device, it may be a file received from another entity, or may be created at the time of the transaction. In one embodiment, a camera or scanner of the computing device may be used to create an image file which is selected for use in the method.

The metadata of the selected electronic file may be edited (203) to insert the transaction information in one or more fields of the metadata in order to generate modified metadata. Specified fields may be used depending on the type of electronic file and/or the type of transaction.

The electronic file may be transmitted (204) with its modified metadata to a receiving entity for transaction processing.

Referring to FIG. 3, a flow diagram (300) illustrates the described method as carried out at a receiving entity (160).

The receiving entity may receive (301) an electronic file with modified metadata from a computing device of a user for transaction processing. The receiving entity may extract (302) the transaction information from the metadata fields of the electronic file. The receiving entity may know which fields contain the transaction processing information for a specific type of electronic file and/or for a specific type of transaction. The receiving entity may then use (303) the transaction information for transaction processing including decrypting the transaction information if required.

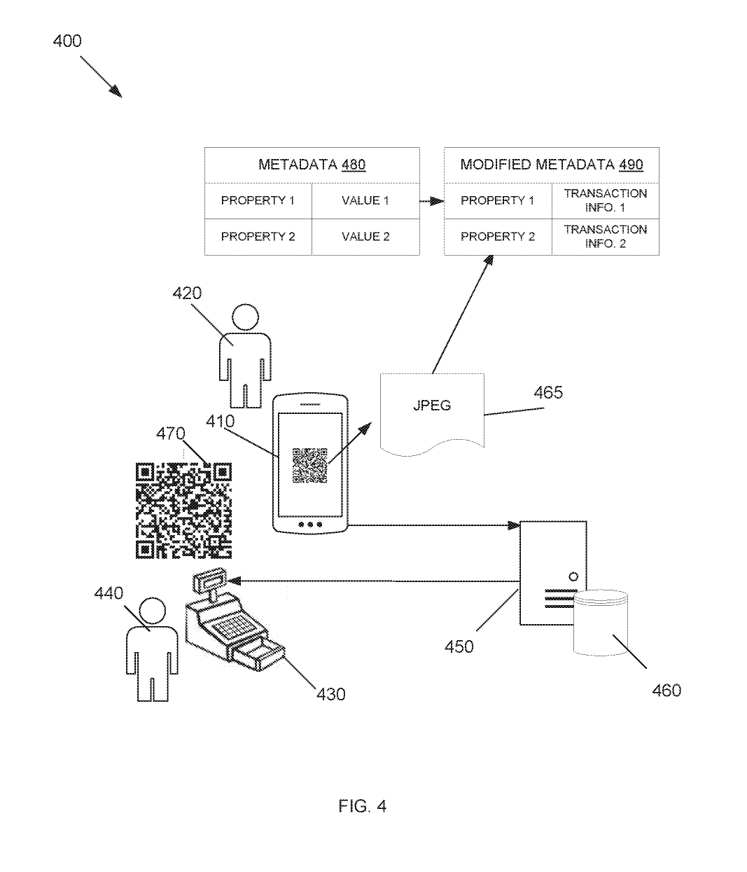

FIGS. 4, 5 and 6 illustrates a first example embodiment. FIG. 4 shows an embodiment of a system (400) for transmitting payment credentials. The system (400) includes a mobile device (410) of a user (420), a point of sale (POS) device (430) in a retail store of a merchant (440), and a payment authorization server (450). The server (450) may have a database (460) associated therewith. The mobile device (410) is in communication with the server (450), which, in turn, is in communication with the POS device (430). In the present embodiment, the mobile device (410) may be a feature phone unable to perform advanced processing functions. Alternatively, the mobile device (410) may be a smartphone, a tablet or other mobile computing device.

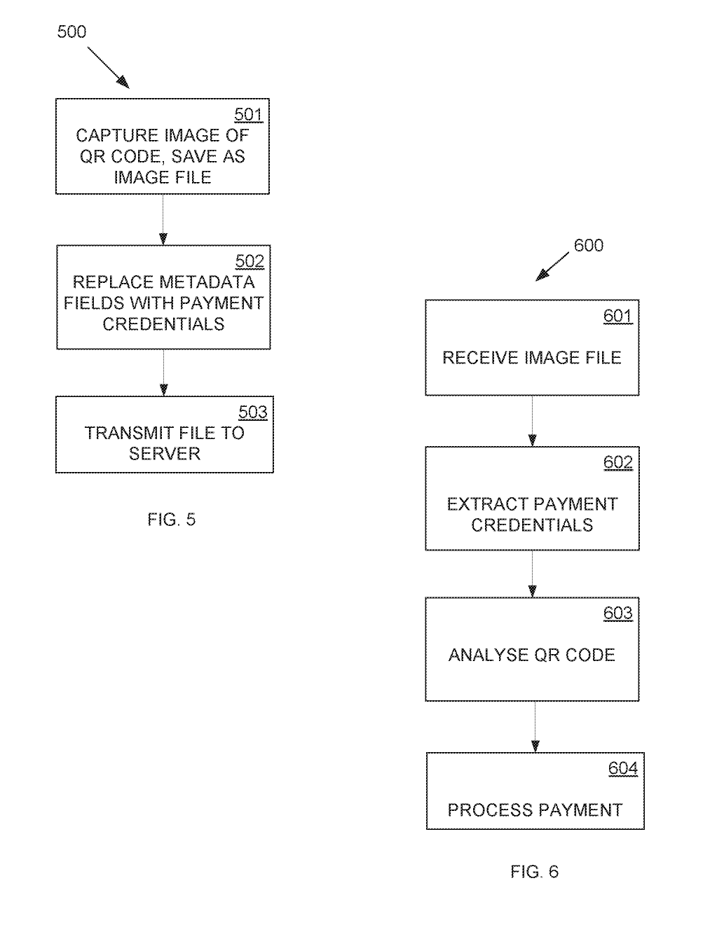

An example embodiment of a method of operation of the system (400) of FIG. 4 is described with reference to the flow diagram (500) of FIG. 5 as it is performed by the mobile device. A user visits a retail store, and takes all products that he or she wishes to buy to a check-out point at which the POS device (430) is located. The products are “rung up” or entered in a normal manner at the POS device (430). When all the items have been rung up, the merchant (440), who is also a payee in the present system, provides the user (420) with a QR code (470). The QR code (470) may include an identifier of the merchant, the total amount payable for the products, and a reference number for the transaction.

In the present embodiment, a mobile application is run on the mobile device which facilitates operation of the method. In a first step (501), the user uses the camera of his or her feature phone to capture, as a JPEG image file (465), an image of the QR code (470). Metadata (480) associated with the image file (465), in the present embodiment metadata in the Exif format defining image file properties including the time and date at which the image has been taken, the flash status, and the orientation of the picture, is automatically created by the mobile device at the time of capturing the image.

A user may then be requested by the mobile application to enter or select payment credentials necessary to process payment, or the mobile application may automatically select payment credentials. The payment credentials required include a financial account number, a branch identifier, and a PIN code. In a next step (502) some of the metadata fields of the image file (465) are replaced by the payment credentials entered by the user. In the present embodiment, the time and date field of the metadata is replaced with the financial account number of the user, the flash status metadata field is replaced with the branch identifier, and the orientation metadata field is replaced with the PIN code. The result of this step (502) is a modified metadata (490).

In a final step (503), the image file with the modified metadata (490) is transmitted to the payment authorisation server (450) over a normal mobile communication network by means of a multimedia messaging service (MMS) message or by using a data connection.

An example embodiment of a method (600) for analysing payment credentials as performed by the payment authorisation server (450) is illustrated in FIG. 6. In a first step (601) the server receives the image file with the modified metadata (490) from the mobile device (410).

In a next step (602), the server extracts the payment credentials from the metadata from expected fields, in the present embodiment the time and date field, the flash status field, and the orientation field.

In a next step (603), the server analyses the image itself so as to extract the details embedded within the QR code (470). From the QR code, the server obtains the merchant identifier, the total amount payable, as well as the transaction reference number.

In a final step (604), the server processes payment to the merchant identified from the QR code, for the amount embedded in the QR code, by identifying the user account from which the amount should be retrieved from the payment credentials extracted from the modified metadata. The database (460) contains details as to which entity should receive money for a specific merchant identifier extracted from the QR code. The transaction reference number may be included as a reference to the transaction in the accounts of both the user and the merchant, and at least the merchant is notified by the server if payment has been successfully processed. After being informed that payment has been successful, the merchant may allow the user to leave his or her store with the products paid for.

It should be noted that the present method allows payment credentials to be transmitted without the need for a mobile device to analyse a QR code. As the analysis is performed at the server, the phone does not require the processing power normally required for such an operation. In addition, only one data file—the image file—is required to be transmitted from the phone to the server, the image file including the necessary transaction information.

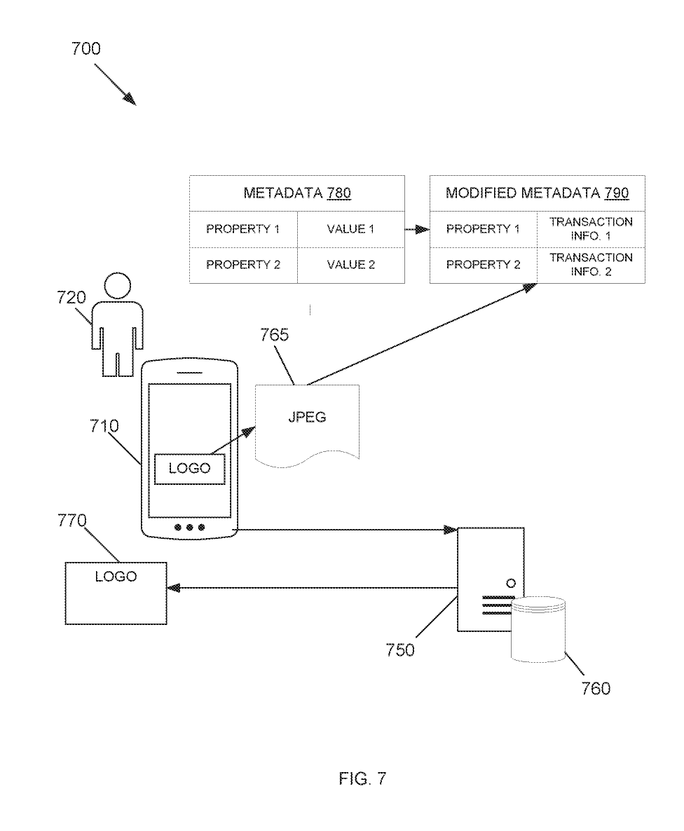

A second embodiment of a system (700) for transmitting payment credentials is illustrated in FIG. 7. The system (700) includes a mobile device (710) of a user (720) and a payment authorization server (750). The payment authorization server (750) has a database (760) associated therewith. The mobile device (710) of this embodiment is a smartphone.

In use, the user (720) visits a retail store, and takes all products that he or she wishes to buy to a check-out point. The items are rung up in a normal manner. When all the items have been rung up, a merchant provides the user with a logo (770) of the store. In the present embodiment, the merchant is one outlet of a retail chain with a multitude of stores in a variety of locations.

A mobile application is run on the mobile device and facilitates operation of a method for transmitting payment credentials. The user uses the camera of his or her smartphone (710) to capture, as a JPEG image file (765), an image of the logo (770). Metadata (780) associated with the JPEG file, in the present embodiment again metadata in the Exif format defining image file properties including the time and date at which the image has been taken, the flash status, the orientation of the picture, and the GPS coordinates at which the picture was taken, is automatically created by the smartphone at the time of capturing the image.

A user is then requested by the mobile application to enter or select payment credentials necessary to process payment. The payment credentials include an amount to be paid, a financial account number, a branch identifier, and a PIN code. The payment credentials entered by the user are then encrypted by the mobile application using a private key unique to the user. Some of the metadata fields of the image file (765) are then replaced by the payment credentials entered by the user. In the present embodiment, the time and date field of the metadata is replaced with the financial account number of the user, the flash status metadata field is replaced with the branch identifier, and the orientation metadata field is replaced with the PIN code. It should be noted that the GPS coordinates are kept in their normal field. The result of this replacement is modified metadata (790).

The image file with the modified metadata (790) is then transmitted to the payment authorisation server (750) over a normal mobile communication network by means of a multimedia messaging service (MMS) message.

The payment authorisation server (750) extracts the encrypted payment credentials from the metadata in expected fields and decrypts it using a public key. The GPS coordinates are extracted directly from the metadata in a standard field.

In the present embodiment, the database (760) contains a list of logos of merchants registered with the server, as well as the geographical coordinates of the merchant's stores. The server performs image recognition on the image itself to determine what retailer the logo in the image belongs to, and looks up a matching logo in the database. The logo (770) is compared to the logos stored in the database (760) in order to identify a specific retailer at which the image was taken. As the merchant in the present embodiment is one outlet of a retail chain with a multitude of stores in a variety of locations, the server uses the GPS coordinates to locate the exact store where the purchase request originates from.

The server then processes payment to the merchant identified from the image analysis and GPS coordinates, for the amount included in the payment credentials, and from the user account included in the payment credentials. It is assumed that the PIN code will be validated in any accepted manner to allow processing of the transaction.

Without the GPS coordinates, identifying a specific merchant would be difficult if the logo of the outlet is the same as the logo of a number of other stores. Accordingly, it should be noted that if a company logo is unique to a specific retailer, for example when the retailer is not one of a number of chain retailers, the GPS coordinates need not be used to uniquely identify the merchant. It may, however, serve as additional identification means.

In an alternative embodiment, a user's mobile device is in communication with the server via a wireless communication network associated with a specific retailer at which he or she wishes to transact, for example a Wi-Fi network. A user captures an image of a barcode on a product that he or she wishes to buy, for example a barcode on a television. The user launches a mobile application on their mobile device which facilitates operation of the system, and instructs the application to transmit an image of the barcode to a payment authorisation server for payment processing purposes. Details required for payment are entered by the user as explained above, and are encrypted before being inserted into standard metadata fields. In the present embodiment, the required details are at least a user's account number and PIN code.

In this embodiment, a unique identifier of the Wi-Fi network is included as part of the payment credentials. The database at the server includes a list of Wi-Fi networks and merchants which are associated with the Wi-Fi networks. By looking up a merchant associated with the specific Wi-Fi identifier, the server can then determine which merchant needs to be paid. Analysis of the image of the barcode will allow the server to know what amount should be paid to the merchant. The merchant and the user may receive notification of a successful transaction to allow the merchant to let the user leave with the product paid for. Alternatively, a user may be provided with an electronic receipt which he or she can show or transmit to the merchant as proof of payment.

It should be noted that this embodiment is more suited to individual purchase items, although multiple transactions may be processed at a single merchant if required.

In a still further embodiment, the database includes a list of merchants registered for use of the system, including an identification picture of the merchants. When a user wishes to pay a merchant, they launch a mobile application which prompts them to capture an image of the merchant's face. Payment credentials may then be entered and included in the metadata as described above.

The user transmits the image with modified metadata to a payment authorization server, which in turn extracts the payment credentials from the metadata as before. In order to identify the merchant, the server performs facial recognition on the image to identify the merchant. If the merchant is found in the list, the server will know which merchant should be paid. In this embodiment, including and having the GPS coordinates of where the picture was taken in the metadata may provide an additional safety factor. Similarly, including a unique Wi-Fi network identifier may provide another level of security. Notification of successful payment may be sent to either or both the merchant and the user. It is envisaged that a transaction identification number may be given by the merchant to the user to include as part of the payment credentials. When the server notifies the merchant that successful payment has occurred for the specific transaction identifier, the merchant may allow the user to leave the store with the products they have paid for.

It would be appreciated that the last example may also be used to transfer money from one person to another, without a transaction having taken place. For example, person A may take a picture of person B, and enter details as to what amount they wish to transfer, and from what account, to person B. The image with modified metadata may be transmitted to a payment authorisation server, which will identify person B and transfer the amount indicated to person B's account, from person A's account.

It should be noted that a person's mobile device number will typically be transmitted as part of an MMS message. This may be used as an additional level of security. If a mobile device number transmitted as part of metadata of an image is not associated with the payment credentials in the metadata, the transaction may automatically be denied.

In at least some embodiments, a merchant to be paid, or a payee, has a unique code. This code may form part of an image to be analysed by the server, or may be entered by the user as part of the payment credentials to be inserted in a metadata field.

A further embodiment is now described in which an e-commerce transaction is carried out by a user using a computing device which may or may not be a mobile device. An invoice may be received as an electronic file at the computing device, for example, as an email message or as an email message attachment. For example, the electronic file in the form of an attachment may be a word document, a spreadsheet file, a portable document format (PDF) file, or any other suitable file format.

The user may access the metadata of the electronic file and insert payment credentials into editable fields of the metadata. In the case of the electronic file being the email message itself, the payment credentials may be inserted into the header of the email. The payment credentials may be card details as copied from a user's card, or may be payment credentials retrieved from an electronic money system accessible from the computing device. The electronic file with modified metadata may then be transmitted either back to the sender or to a payment authority for processing.

In a further aspect of this embodiment, the entire electronic file with the modified metadata may be encrypted before sending in order to provide a further security layer.

A further embodiment is described in which the transaction information is identity information which may be used for verifying a user's identity, for example, to allow them access to a location.

A user may access an electronic file such as an existing photograph of the user, a document of the user, or may capture a photograph at the current location. As in some of the previous embodiments, some of the existing metadata of the electronic file may be kept such as GPS coordinates showing the current location, a time and a date of the electronic file, etc.

The metadata may be modified to include identity information such as an identity number, a passport number or license number. The identity information may be encrypted before entering into the metadata to ensure protection of the information. The electronic file with the modified metadata may then be sent to a receiving entity in the form of an authorizing server which may extract the identity information, decrypt it if appropriate, and use it to authenticate the user.

Additionally, if the electronic file is an image of the user, the image may be processed by the authorizing server to facially identify the user as well as the provided identity information. Additionally the existing metadata of the image may provide further verification of the current location and that the user was at the location at the time of capture of the image.

It is understood that features described in one or more of the described embodiments may be used in any of the other embodiment where appropriate.

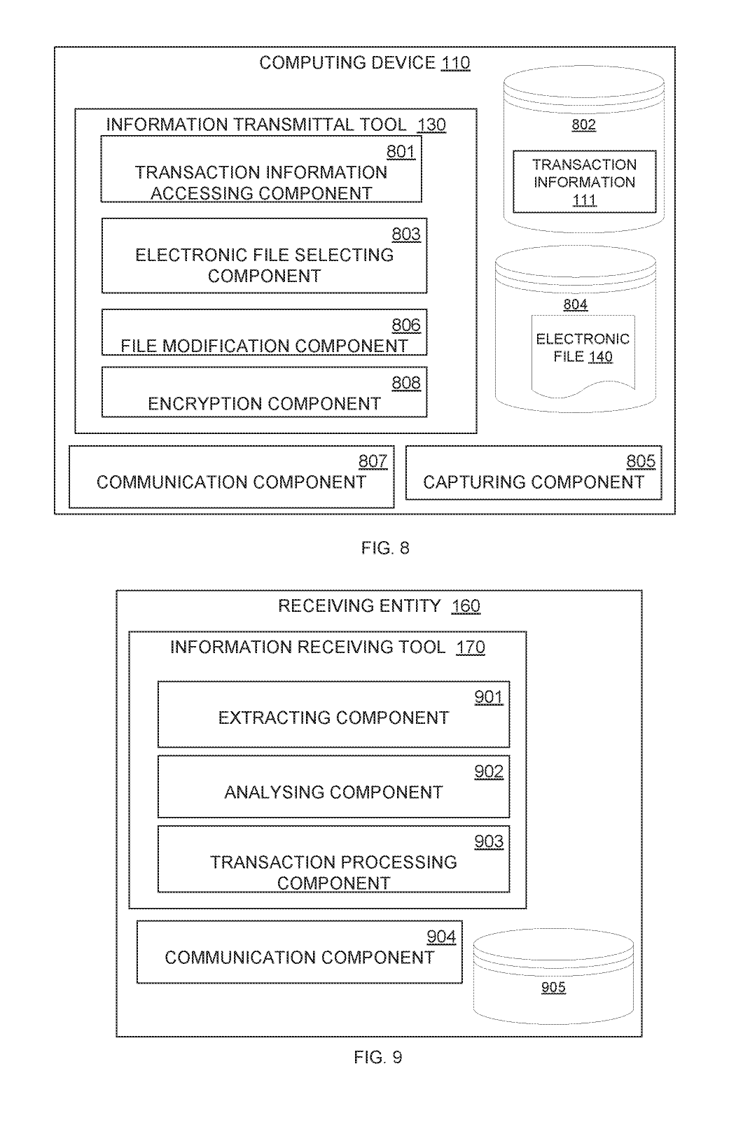

FIG. 8 shows a computing device (110) for use in the system and method described with reference to FIG. 1 and FIG. 2 and the other described embodiments. The computing component (110) includes an information transmittal tool (130) providing the described functionality.

The information transmittal tool (130) includes a transaction information accessing component (801) for accessing transaction information (111) which may be stored in a storage medium (802) of the computing device (110) or may be accessed from a remote location or input manually by a user. An electronic file selecting component (803) may be provided for selecting an electronic file (140). The electronic file (140) may be stored in a storage medium (804) of the computing device (110) or may be captured by a capturing component (805) of the computing device (110) which may be a camera or a scanner of the computing device (110) and provided directly to the information transmittal tool (130).

The capturing component (805) may be used to capture an image relating to at least a product or party to the transaction in respect of which a user wishes to make a financial transaction.

The information transmittal tool (130) includes a file modification component (806) which is used to replace metadata of the image file with transaction information.

A communication component (807) is used to transmit the electronic file with modified metadata to a receiving entity. In some embodiments, the communication component is a network antenna by means of which data can be transmitted over a standard mobile device communications network. It should be noted that the communication component may be any communication component which allows transmission of data, including, but not limited to, a Wi-Fi module, and a Bluetooth module.

An encryption component (808) may be used to encrypt transaction information before replacing metadata of the electronic file with the transaction information. The encryption component may be a processor and may work in combination with an application of the computing device. It should be noted that the encryption component may also be a hardware security module (HSM) integrated into the computing device.

FIG. 9 shows a receiving entity (160) which includes an information receiving tool (170) providing the described functionality for receiving transaction information. It should be noted that the computing device (110) may also be a receiving entity (160) and the receiving entity (160) may also include the functionality for transmitting transaction information as described in the computing device (110).

The information receiving tool (170) may include a communication component (904) for receiving an electronic file with modified metadata. An extracting component (901) may extract transaction information from the electronic file and a transaction processing component (903) may use the transaction information to process a transaction. If the transaction information is encrypted the transaction processing component (903) may include a decryption component.

In one embodiment, the receiving entity may be a payment authorization server. The information receiving tool (170) may include an analysing component (902) for analysing the electronic file, including determining what product or party the file relates to. A database (905) may be associated with the server and may include a list of products or payees and entities associated therewith, as well as a lookup component.

In use in one embodiment, the communication component (904) receives an image file having payment credentials in metadata associated therewith from a user, the image of the image file relating to at least a product or a payee in respect of which a user wishes to make a financial transaction. In one embodiment, the image is of a logo of a merchant. The extracting component (901) extracts the payment credentials from the metadata, and a decryption component may decrypts the payment credentials into a readable format.

The analysing component (902) analyses the image. The logo in the image is compared to logos stored in the list in the database (905), and, once a matching logo has been identified by means of the lookup component of the database, the transaction processing component (903) processes payment using the decrypted payment credentials to the entity associated with the matching logo in the database.

It should be noted that although the embodiments described above considered the use of the Exif standard as metadata format for images, other standard may just as well be used. Other standards include, but is not limited to, International Press and Telecommunications Council's Information Interchange Model (IPTC-IIM), International Press and Telecommunications Council's Core and Extension, Picture Licensing Universal System (PLUS), Extensible Metadata Platform (XMP), and Dublin Core.

Additionally, although only a small number of metadata fields in the Exif format has been mentioned, any standard field be used to store payment credentials. Similarly, a user may be required to enter a number of payment credentials, including a card type, a card verification value (CVV), an expiry date, a name on card, or the like.

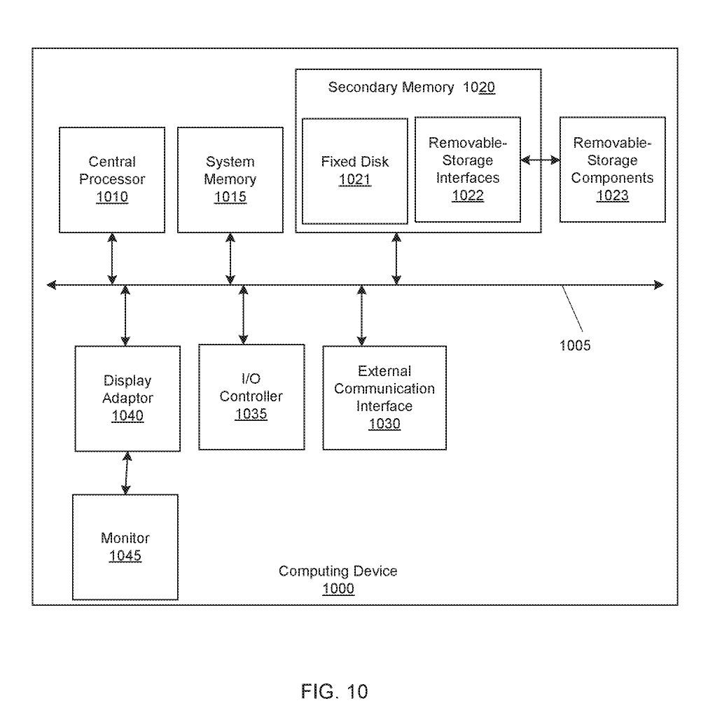

FIG. 10 illustrates an example of a computing device (1000) in which various aspects of the disclosure may be implemented. The computing device (1000) may be suitable for storing and executing computer program code. The various participants and elements in the previously described system diagrams may use any suitable number of subsystems or components of the computing device (1000) to facilitate the functions described herein.

The computing device (1000) may include subsystems or components interconnected via a communication infrastructure (1005) (for example, a communications bus, a cross-over bar device, or a network). The computing device (1000) may include at least one central processor (1010) and at least one memory component in the form of computer-readable media.

The memory components may include system memory (1015), which may include read only memory (ROM) and random access memory (RAM). A basic input/output system (BIOS) may be stored in ROM. System software may be stored in the system memory (1015) including operating system software.

The memory components may also include secondary memory (1020). The secondary memory (1020) may include a fixed disk (1021), such as a hard disk drive, and, optionally, one or more removable-storage interfaces (1022) for removable-storage components (1023).

The removable-storage interfaces (1022) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (1022) may also be in the form of ports or sockets for interfacing with other forms of removable-storage components (1023) such as a flash memory drive, external hard drive, or removable memory chip, etc.

The computing device (1000) may include an external communications interface (1030) for operation of the computing device (1000) in a networked environment enabling transfer of data between multiple computing devices (1000). Data transferred via the external communications interface (1030) may be in the form of signals, which may be electronic, electromagnetic, optical, radio, or other types of signal.

The external communications interface (1030) may enable communication of data between the computing device (1000) and other computing devices including servers and external storage facilities. Web services may be accessible by the computing device (1000) via the communications interface (1030).

The external communications interface (1030) may also enable other forms of communication to and from the computing device (1000) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (1010).

A computer program product may be provided by a non-transient computer-readable medium, or may be provided via a signal or other transient means via the communications interface (1030).

Interconnection via the communication infrastructure (1005) allows a central processor (1010) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (1000) either directly or via an I/O controller (1035). These components may be connected to the computing device (1000) by any number of means known in the art, such as a serial port.

One or more monitors (1045) may be coupled via a display or video adapter (1040) to the computing device (1000).

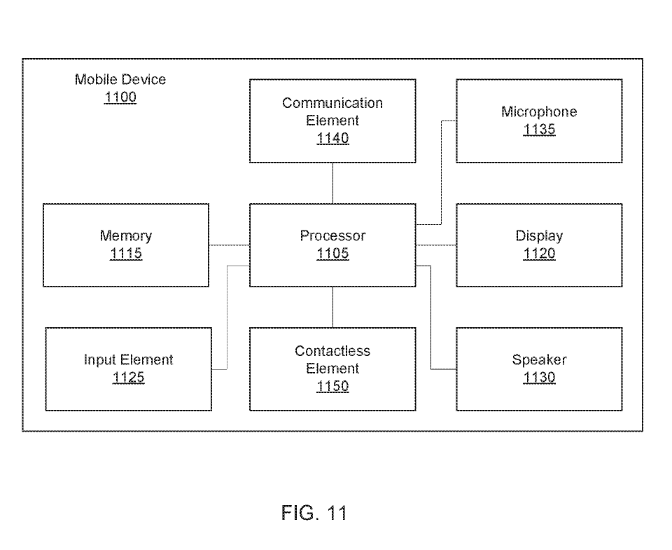

FIG. 11 shows a block diagram of a mobile device (1100) that may be used in embodiments of the disclosure. The mobile device (1100) may be a cell phone, a feature phone, a smart phone, a satellite phone, or a computing device having a phone capability.

The mobile device (1100) may include a processor (1105) (e.g., a microprocessor) for processing the functions of the mobile device (1100) and a display (1120) to allow a user to see the phone numbers and other information and messages. The mobile device (1100) may further include an input element (1125) to allow a user to input information into the device (e.g., input buttons, touch screen, etc.), a speaker (1130) to allow the user to hear voice communication, music, etc., and a microphone (1135) to allow the user to transmit his or her voice through the mobile device (1100).

The processor (1110) of the mobile device (1100) may connect to a memory (1115). The memory (1115) may be in the form of a computer-readable medium that stores data and, optionally, computer-executable instructions.

The mobile device (1100) may also include a communication element (1140) for connection to communication channels (e.g., a cellular telephone network, data transmission network, Wi-Fi network, satellite-phone network, Internet network, Satellite Internet Network, etc.). The communication element (1140) may include an associated wireless transfer element, such as an antenna.

The communication element (1140) may include a subscriber identity module (SIM) in the form of an integrated circuit that stores an international mobile subscriber identity and the related key used to identify and authenticate a subscriber using the mobile device (1100). One or more subscriber identity modules may be removable from the mobile device (1100) or embedded in the mobile device (1100).

The mobile device (1100) may further include a contactless element (1150), which is typically implemented in the form of a semiconductor chip (or other data storage element) with an associated wireless transfer element, such as an antenna. The contactless element (1150) may be associated with (e.g., embedded within) the mobile device (1100) and data or control instructions transmitted via a cellular network may be applied to the contactless element (1150) by means of a contactless element interface (not shown). The contactless element interface may function to permit the exchange of data and/or control instructions between mobile device circuitry (and hence the cellular network) and the contactless element (1150).

The contactless element (1150) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the mobile device (1100) and an interrogation device. Thus, the mobile device (1100) may be capable of communicating and transferring data and/or control instructions via both a cellular network and near field communications capability.

The data stored in the memory (1115) may include: operation data relating to the operation of the mobile device (1100), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the mobile device (1100) to selected receivers.

The mobile device (1100) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for transmitting transaction information, the method performed on a computing device and including the steps of:
accessing transaction information to be transmitted;
selecting an electronic file;
editing metadata stored in the electronic file to insert the transaction information into one or more fields of the metadata to provide modified metadata of the electronic file; and
transmitting the electronic file with the modified metadata to a receiving entity for processing of the transaction information.

2. The method as claimed in claim 1, wherein the transaction information is in the form of payment credentials usable to enable a payment transaction.

3. The method as claimed in claim 2, wherein the payment credentials are one or more of the group of: encrypted payment credentials, a token referencing payment credentials, or single use payment credentials.

4. The method as claimed in claim 1, wherein the electronic file content includes information to be used in the transaction.

5. The method as claimed in claim 1, wherein one or more existing fields of the metadata stored in the electronic file is kept in the modified metadata and used in the transaction.

6. The method as claimed in claim 5, wherein the one or more existing fields of the metadata include one or more of: time and date information, and location information.

7. The method as claimed in claim 1, wherein selecting an electronic file includes capturing as an image file an image relating to a product or a party to the transaction in respect of which a user wishes to make a financial transaction.

8. The method as claimed in claim 7, wherein the image is an image of any one or more of the group of: a product, a barcode, a two-dimensional barcode, a quick response (QR) code, a retailer identifier, and a person.

9. A method for receiving transaction information, the method performed on a computing device at a receiving entity and including the steps of:
receiving an electronic file with modified metadata;
extracting transaction information from one or more fields of the modified metadata stored in the electronic file; and
using the transaction information to process a transaction.

10. The method as claimed in claim 9, wherein the method is performed on a payment authorisation server and includes the steps of:
receiving an image file having payment credentials in metadata associated therewith from a user, the image of the image file relating to a product or a party to the transaction in respect of which a user wishes to make a financial transaction;
analysing the image file in order to determine what product or party the image file relates to; and
processing the payment credentials to effect the payment to an entity associated with the product or party.

11. The method as claimed in claim 10, including the step of looking up an entity associated with the product or party or a product or party identifier in a database associated with the server.

12. A system for transmitting transaction information comprising including:
a transaction information accessing component for accessing transaction information to be transmitted;
an electronic file selecting component for selecting an electronic file;
a file modification component for editing metadata stored in the electronic file to insert the transaction information into one or more fields of the metadata to provide modified metadata of the electronic file; and
a communication component for transmitting the electronic file with the modified metadata to a receiving entity for processing of the transaction information.

13. The system as claimed in claim 12, including:
a capturing component for capturing an electronic file in the form of an image file having an image relating to at least a product or a party in respect of which a user wishes to make a financial transaction.

14. The system as claimed in claim 12, including:
an encryption component for encrypting the transaction information prior to editing metadata to insert the transaction information.

15. A system for receiving transaction information at a receiving entity comprising:
a communication component for receiving an electronic file with modified metadata;
an extracting component for extracting transaction information from one or more fields of the modified metadata stored in the electronic file; and
a transaction processing component for using the transaction information to process a transaction.

16. The system as claimed in claim 15, wherein:
the communication component is for receiving an image file having payment credentials in metadata associated therewith from a user and the image of the image file relating to at least a product or a party to the transaction in respect of which a user wishes to make a financial transaction; and including:
an analysing component for analysing the image file in order to determine what product or party the image file relates to; and
a payment processing component for processing the payment credentials to effect the payment to an entity associated with the product or party.

17. A computer program product for transmitting transaction information, the computer program product comprising a computer-readable medium having stored computer-readable program code for performing the steps of:
accessing transaction information to be transmitted;
selecting an electronic file;
editing metadata stored in the electronic file to insert the transaction information into one or more fields of the metadata to provide modified metadata of the electronic file; and
transmitting the electronic file with the modified metadata to a receiving entity for processing of the transaction information.

18. A computer program product for receiving transaction information, the computer program product comprising a computer-readable medium having stored computer-readable program code for performing the steps of:
receiving an image file having payment credentials in metadata associated therewith from a user, the image of the image file relating to at least a product or a payee in respect of which a user wishes to make a financial transaction;
analysing the image file in order to determine what product or payee the image file relates to; and
processing the payment credentials to effect the payment to an entity associated with the product or payee.
